(19) United States
(12) Patent Application Publication
(10) Pub. No.: US 2011/0131662 A1
(43) Pub. Date: Jun. 2, 2011

(54) INFORMATION PROCESSOR AND LOCK SETTING METHOD

(75) Inventor: Yoshio MATSUOKA, Ome-shi (JP)

(73) Assignee: KABUSHIKI KAISHA TOSHIBA, Tokyo (JP)

(21) Appl. No.: 12/838,345

(22) Filed: Jul. 16, 2010

(30) Foreign Application Priority Data
Nov. 30, 2009 (JP) 2009-272269

(51) Int. Cl. G06F 21/00

(52) U.S. Cl. 726/26

(57) ABSTRACT

According to one embodiment, an information processor includes a checker and a lock enabling module. The checker checks whether each of different types of lock mechanisms is enabled. When the lock mechanisms include an enabled lock mechanism, the lock enabling module enables a lock mechanism other than the enabled lock mechanism.

### CROSS-REFERENCE TO RELATED APPLICATIONS

This application is based upon and claims the benefit of priority from Japanese Patent Application No. 2009-272269, filed Nov. 30, 2009, the entire contents of which are incorporated herein by reference.

### FIELD

Embodiments described herein relate generally to an information processor and a lock setting method.

### BACKGROUND

Some information processors such as personal computers (PCs) are provided with a lock mechanism to prevent unauthorized use when stolen. For example, the lock mechanism forcibly shuts down the information processor in response to a login authentification failure or a remote notification to lock the operation, data access, and the like. Japanese Patent Application Publication (KOKAI) No. 2007-12028 discloses a conventional technology in which a signal indicating PC lock is sent to a terminal via a communication network to remotely lock the terminal.

With the conventional technology, a lock mechanism other than the remote lock mechanism cannot be enabled. More specifically, in the case of an information processor provided with different types of lock mechanisms, if the information processor is remotely locked by one of the lock mechanisms, another lock mechanism cannot be effectively used. That is, even if the information processor is provided with a plurality of lock mechanisms, the lock mechanisms cannot improve the security to prevent unauthorized use.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view of an information processor according to an embodiment;

FIG. 2 is an exemplary block diagram of the system configuration of the information processor in the embodiment;

FIG. 3 is an exemplary flowchart of the operation of the information processor when booted in the embodiment; and

FIG. 4 is an exemplary schematic diagram of a set-up screen in the embodiment.

### DETAILED DESCRIPTION

In general, according to one embodiment, an information processor comprises a checker and a lock enabling module. The checker is configured to check whether each of different types of lock mechanisms is enabled. The lock enabling module is configured to enable, when the lock mechanisms includes an enabled lock mechanism, a lock mechanism other than the enabled lock mechanism.

According to another embodiment, there is provided a lock setting method comprising: a checker checking whether each of different types of lock mechanisms is enabled; and a lock enabling module enabling, when the lock mechanisms includes an enabled lock mechanism, a lock mechanism other than the enabled lock mechanism.

An embodiment will be set forth in detail with reference to the drawings, in which like reference numerals refer to like elements throughout, and a redundant description will not be provided.

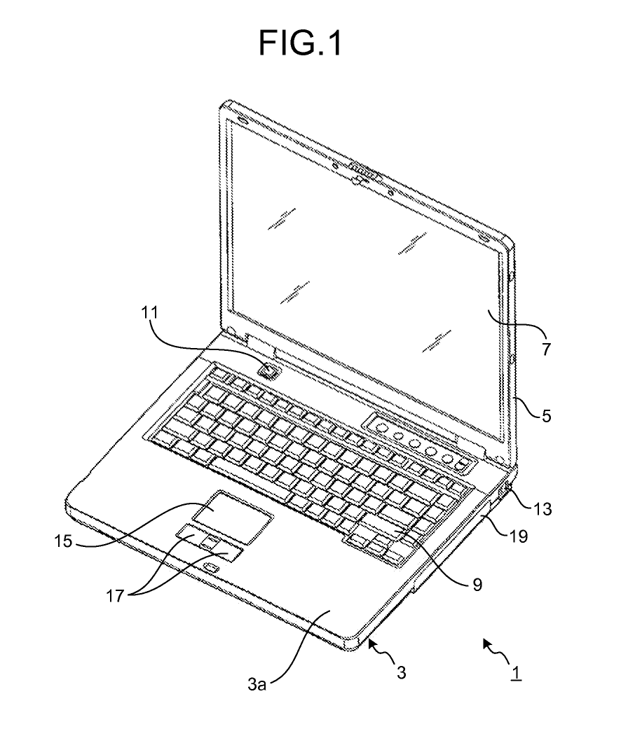

FIG. 1 is a perspective view of an information processor 1 according to the embodiment. As illustrated in FIG. 1, the information processor 1 is a notebook personal computer (PC). Although the information processor 1 is described by way of example as a notebook PC in the embodiment, it is not so limited and may be any device such as a desktop PC.

The information processor 1 comprises a main body 3 and a display module 5. Embedded in the display module 5 is a display device comprising a liquid crystal display (LCD) 7. The display screen of the LCD 7 is located substantially in the center of the display module 5.

The display module 5 is rotatably supported on the main body 3. This allows the display module 5 to rotate between a closed position and an open position with respect to the main body 3. The main body 3 comprises a housing 3a formed in a flat box shape. Arranged on the upper surface of the housing 3a are a keyboard 9 comprising various keys, a power button 11 to turn on/off the information processor 1, a touchpad 15, a click button 17, and the like. Arranged on a side of the housing 3a are a communication I/F 13 to connect to a local area network (LAN), the Internet, etc., and a slot 19 through which a large capacity storage medium such as a digital versatile disk (DVD) is inserted into or ejected from the housing 3a.

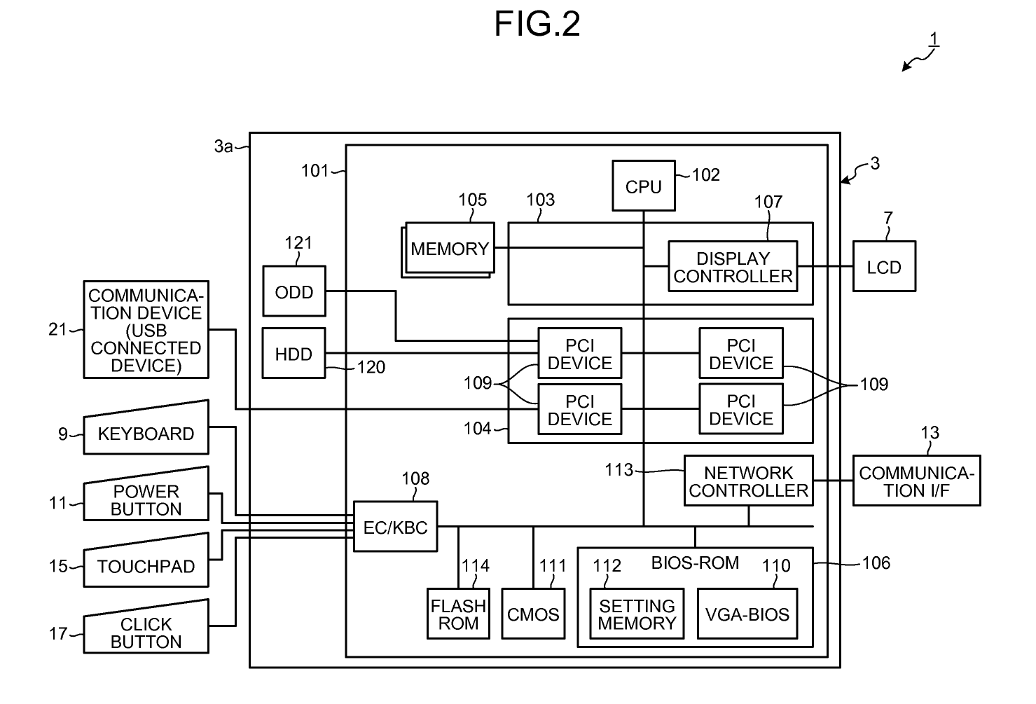

FIG. 2 is a block diagram of an example of the system configuration of the information processor 1. As illustrated in FIG. 2, the information processor 1 comprises a mother board 101 that is built in the housing 3a of the main body 3. The mother board 101 has chips, such as a central processing unit (CPU) 102, a north bridge 103, a south bridge 104, and the like, mounted thereon.

The CPU 102 controls the overall operation of the information processor 1. More specifically, the CPU 102 executes a system basic input-output system (BIOS), an operating system (OS), various application programs loaded from an optical disk drive (ODD) 121, a BIOS-read only memory (ROM) 106, and the like into a memory 105, and outputs a control signal to each module, thereby controlling the operation of the information processor 1.

The north bridge 103 is a chip that controls memory, display, and the like. The south bridge 104 is a chip that controls each device on a peripheral component interconnect (PCI) bus as well as a low pin count (LPC) bus. The north bridge 103 comprises a display controller 107 that is connected to the LCD 7 of the display module 5. A hard disk drive (HDD) 120 is built in the housing 3a to store the OS, the application programs, data files, and the like. The ODD 121 is also built in the housing 3a. A large capacity storage medium such as a DVD medium can be inserted into the ODD 121 from the outside through the slot 19. The ODD 121 writes data to a large capacity storage medium inserted through the slot 19 as well as reading data stored in advance.

The south bridge 104 comprises a PCI device 109 such as a serial advanced technology attachment (SATA) controller, a universal serial bus (USB) controller, and the like. USB connected devices such as the HDD 121, the ODD 121, and a communication device 21 are connected via the PCI device 109 to the south bridge 104. The communication device 21 provides access to the mobile communication service offered to the public by a communications carrier, and performs data communication through, for example, a third-generation communication system.

Further mounted on the mother board 101 are the memory 105, the BIOS-ROM (BIOS memory) 106, an embedded controller/keyboard controller (EC/KBC) 124, a complementary metal-oxide-semiconductor (CMOS) 111, a network controller 113, and a flash ROM 114. The memory 105 may be, for example, a random access memory (RAM). The BIOS-ROM 106 is a rewritable nonvolatile memory.

Programs such as BIOS and OS are loaded into the memory 105 and executed. The BIOS-ROM 106 stores a BIOS program for controlling the information processor 1. The BIOS-ROM 106 comprises a video graphics array (VGA)-BIOS 110 and a setting memory 112. The VGA-BIOS 110 stores a program for controlling the display controller 107. The setting memory 112 is a nonvolatile memory that stores various types of setting information.

The EC/KBC 108 is a chip comprising the integration of an embedded controller (EC) for power management and a keyboard controller (KBC) for controlling the keyboard 9, the touchpad 15, and the click button 17. The EC/KBC 108 has the function of turning on/off the information processor 1 in response to user's operation on the power button 11. The EC/KBC 108 receives input from the keyboard 9, the touchpad 15, and the click button 17.

The CMOS 111 and the flash ROM 114 store information necessary to boot the information processor 1. The network controller 113 communicates with an external network such as LAN and the Internet connected via the communication I/F 13.

The information processor 1 is provided with a lock mechanism to lock the operation of the information processor 1, data access on the information processor 1, and the like in response to the failure of user authentication using a password, a notification received via the communication device 21 and the communication I/F 13, or the like as a trigger. The lock mechanism is implemented by the CPU 102 executing a program stored in the BIOS-ROM 106, the HDD 120, or the like, or the control of a dedicated engine provided in the south bridge 104. The operation of the information processor 1 locked by the lock mechanism may include, in addition to the execution of the OS and the application programs, deletion of data stored in the HDD 120 and the like. The state where the operation of the information processor 1 or data access on the information processor 1 is locked by the lock mechanism will be hereinafter referred to as “locked state”. The lock mechanism prevents the unauthorized use of the information processor 1. Further, even if the information processor 1 is stolen, the lock mechanism is capable of remotely locking the information processor 1.

The lock mechanism includes a plurality of types of lock mechanisms. It is assumed herein that the information processor 1 is provided with three lock mechanisms, i.e., a first lock mechanism, a second lock mechanism, and a third lock mechanism. Note that the number of the lock mechanisms is not limited to three, and there may be any number of lock mechanisms, at least two.

The first lock mechanism is remotely enabled/disabled in response to a notification from a third-generation communication system connected via the communication device 21. The status where the first lock mechanism is enabled/disabled is stored in a predetermined area of the flash ROM 114 upon receipt of a notification from the remote by the third-generation communication system. In the information processor 1, the CPU 102 refers to the status stored in the flash ROM 114 at regular intervals. When the status is one where the first lock mechanism is enabled, the CPU 102 executes a predetermined program to activate the first lock mechanism.

The second lock mechanism is remotely enabled/disabled in response to a notification from a server on the LAN or the Internet connected via the communication I/F 13. The status where the second lock mechanism is enabled/disabled is stored in a predetermined area of the CMOS 111 upon receipt of a notification from the remote server on the LAN or the Internet. In the information processor 1, the CPU 102 refers to the status stored in the CMOS 111 at regular intervals. When the status is one where the second lock mechanism is enabled, the CPU 102 executes a predetermined program to activate the second lock mechanism.

The third lock mechanism is implemented by the control of a dedicated management engine (ME) provided in the south bridge 104. The ME monitors the state of the information processor 1 by polling each module thereof. When there is neither user authentication failure nor a notification received by communication through the communication I/F 13 and the communication device 21 to enable a lock, the ME operates in normal mode in which locking is not performed. When user authentication fails or a notification is received by communication through the communication I/F 13 and the communication device 21 to enable a lock, the ME enters theft mode in which locking is performed. Accordingly, for example, the CPU 102 is limited to access the south bridge 104 so that the operation of the information processor 1 is limited. The CPU 102 checks the mode in which the ME is operating, i.e., the status where the third lock mechanism is enabled/disabled, through a management engine BIOS extension (MEBx) of the ME having BIOS I/F function.

The types of the first to third lock mechanisms are described above by way of example only and not in any limitative sense. For example, any one of the first to third lock mechanisms may lock the information processor 1 by writing the status where the lock mechanism is enabled to a nonvolatile memory such as the flash ROM 114 when user authentication fails due to an incorrect password or on a fingerprint authentication device (not illustrated).

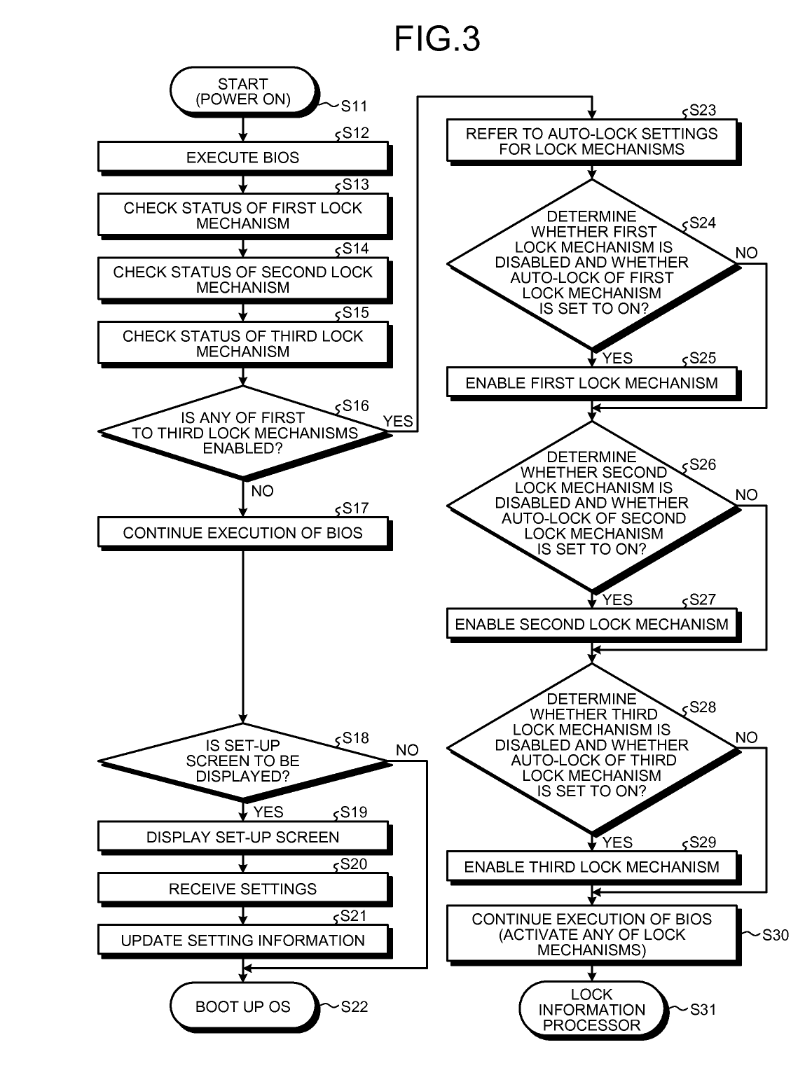

With reference to FIG. 3, a description will be given of the operation of the information processor 1 when booted. FIG. 3 illustrates an example of the operation of the information processor 1 of the embodiment when booted.

As illustrated in FIG. 3, when the information processor 1 is turned on by the power button 11 (S11), the EC/KBC 108 notifies the CPU 102 of this event. In response to the notification, the CPU 102 loads the BIOS program from the BIOS-ROM 106 into the memory 105 and executed it (S12).

Thereafter, the CPU 102 checks the status of the first to third lock mechanisms (S13 to S15). More specifically, the CPU 102 accesses the flash ROM 114 to check the status indicating whether the first lock mechanism is enabled or disabled. Further, the CPU 102 accesses the CMOS 111 to check the status indicating whether the second lock mechanism is enabled or disabled. Still further, the CPU 102 accesses the ME via the MEBx to check the status indicating whether the third lock mechanism is enabled or disabled.

By the status check at S13 to S15, the CPU 102 determines whether the first to third lock mechanisms are enabled (S16). If none of the first to third lock mechanisms is enabled, and all of them are disabled (No at S16), the CPU 102 continues the execution of the BIOS program in a normal manner (S17).

After S17, the CPU 102 determines whether to display a set-up screen to perform various types of set-up operations based on whether a predetermined key to display the set-up screen is pressed on the keyboard 9 (S18). When the predetermined key is pressed on the keyboard 9 and the set-up screen is displayed (Yes at S18), the CPU 102 reads the VGA-BIOS 110 to sequentially execute as well as reading current setting information from the setting memory 112 to display the set-up screen on the LCD 7 (S19). Thus, the CPU 102 receives input for settings from the user through the keyboard 9 or the like (S20).

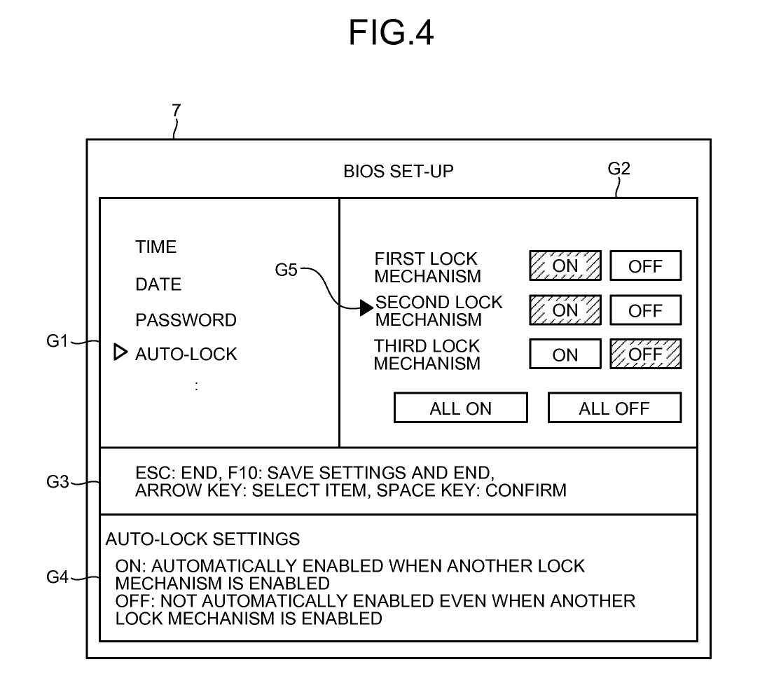

FIG. 4 illustrates an example of the set-up screen. As illustrated in FIG. 4, at S19, the LCD 7 displays the set-up screen including an item select area G1, a detailed setting area G2, an operation guide display area G3, a setting guide display area G4, a cursor G5, and the like. The item select area G1 displays setting items and receives a selection of a setting item with the cursor G5. The detailed setting area G2 receives detailed settings as to the setting item selected in the item select area G1 with the cursor G5. The operation guide display area G3 displays operation guide on the set-up screen. The setting guide display area G4 displays guidance about the setting item selected in the item select area G1 and the detailed settings as to the setting item.

On the set-up screen illustrated in FIG. 4, an item “Auto-lock” is selected in the item select area G1, and auto-lock settings are specified. In the auto-lock settings, it is set whether each lock mechanism of the information processor 1 is to be automatically enabled when another lock mechanism is enabled. For example, to automatically enable the second lock mechanism when the first and the third lock mechanisms are enabled, “ON” is selected by using, for example, an arrow key while the cursor G5 is placed on the “second lock mechanism” in the detailed setting area G2. On the other hand, if not to automatically enable the second lock mechanism even when the first and the third lock mechanisms are enabled, “OFF” is selected by using the arrow key or the like. The auto-lock settings may be specified all together by selecting an item for automatically enabling/disabling all the lock mechanisms.

In this manner, the set-up screen allows the settings to be specified as to whether to automatically enable/disable each of the first to third lock mechanisms. In the example of FIG. 4, the auto-lock of the first and the second lock mechanisms is set to “ON”, while that of the third lock mechanism is set to “OFF”. Accordingly, the first and the second lock mechanisms are automatically enabled when another lock mechanism is enabled. On the other hand, the third lock mechanism is not enabled even when another lock mechanism is enabled.

Referring back to FIG. 3, the CPU 102 updates the setting information in the setting memory 112 with the settings received at S20 (S21). With this, the auto-lock settings are updated. The setting information may be updated at S21 only upon receipt of an instruction for update from the keyboard 9 or the like. When the set-up screen is not displayed (No at S18), and after the setting information is updated in the setting memory 112 at S21, the CPU 102 continues the execution of the BIOS program to load the OS stored in the HDD 120 into the memory 105, thereby booting up the OS (S22).

If at least one of the first to third lock mechanisms is enabled (Yes at S16), the CPU 102 refers to the auto-lock settings for the lock mechanism from the setting information stored in the flash ROM 114 (S23).

After that, the CPU 102 determines whether the first lock mechanism is disabled based on the status check and whether the auto-lock of the first lock mechanism referred to at S23 is set to “ON” (S24). If the first lock mechanism is disabled and the auto-lock of the first lock mechanism is set to “ON” (Yes at S24), the CPU 102 rewrites the status stored in the flash ROM 114 as “the first lock mechanism is enabled” to enable the first lock mechanism (S25). If the auto-lock of the first lock mechanism is set to “OFF” (No at S24), the process moves to S26. That is, when the auto-lock of the first lock mechanism is ON, the first lock mechanism is automatically enabled together with another lock mechanism at S25.

Similarly, the CPU 102 determines whether the second lock mechanism is disabled based on the status check and whether the auto-lock of the second lock mechanism referred to at S23 is set to “ON” (S26). If the second lock mechanism is disabled and the auto-lock of the second lock mechanism is set to “ON” (Yes at S26), the CPU 102 rewrites the status stored in the CMOS 111 as “the second lock mechanism is enabled” to enable the second lock mechanism (S27). If the auto-lock of the second lock mechanism is set to “OFF” (No at S26), the process moves to S28. That is, when the auto-lock of the second lock mechanism is ON, the second lock mechanism is automatically enabled together with another lock mechanism at S27.

Similarly, the CPU 102 determines whether the third lock mechanism is disabled based on the status check and whether the auto-lock of the third lock mechanism referred to at S23 is set to “ON” (S28). If the third lock mechanism is disabled and the auto-lock of the third lock mechanism is set to “ON” (Yes at S28), the CPU 102 hooks polling each module of the information processor 1 performed by the ME and notifies the ME of dummy information such as user authentication failure to enable the third lock mechanism (S29). If the auto-lock of the third lock mechanism is set to “OFF” (No at S28), the process moves to S30. That is, when the auto-lock of the third lock mechanism is ON, the third lock mechanism is automatically enabled together with another lock mechanism at S29.

The CPU 102 continues the execution of the BIOS program (S30). At this time, any of the first to third lock mechanisms the status of which is enable is activated. Thus, the information processor 1 is locked (S31).

For example, if the status stored in the flash ROM 114 is “enable”, the first lock mechanism is activated. The BIOS forcibly shuts down the information processor 1 without booting up the OS to thereby lock the information processor 1. If there is a plurality of lock mechanisms the status of which is enable, the enabled lock mechanisms are sequentially activated. In this case, forcible shut down of the information processor 1, termination of the BIOS execution, and the like are not performed until the individual lock mechanisms lock the information processor 1. Accordingly, at S31, the information processor 1 is locked by all the enabled lock mechanisms. This increases the security to prevent unauthorized use.

As described above, according to the embodiment, under the control of the CPU 102, the information processor 1 checks whether each of different types of lock mechanisms is enabled. When any of the lock mechanisms is enabled, a disabled lock mechanism other than the enabled lock mechanism is automatically enabled together with the enabled lock mechanism. Thus, the security can be increased by a plurality of lock mechanisms.

The application program executed on the information processor 1 may be provided as being stored in advance in ROM or the like. The application program may also be provided as being stored in a computer-readable storage medium, such as a compact disk read-only memory (CD-ROM), a flexible disk (FD), a compact disc-recordable (CD-R), or a digital versatile disc (DVD), in an installable or executable format.

The application program executed on the information processor 1 may also be stored in a computer connected via a network such as the Internet so that it can be downloaded therefrom via the network. Further, the application program may be provided or distributed via a network such as the Internet.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processor comprising:
a checker configured to check whether a plurality of lock modules are enabled; and
a lock enabling module configured to enable a disabled lock module, if at least one of the plurality of lock modules is enabled.

2. The information processor of claim 1, further comprising a setting module configured to set whether to enable each lock module in accordance with the enabled lock module, wherein
the lock enabling module is configured to enable the lock module other than the enabled lock module when the lock module is set to be enabled in accordance with the enabled lock module.

3. The information processor of claim 1, wherein the lock modules are configured to individually lock operation of the information processor or data access on the information processor when enabled.

4. A lock setting method comprising:
checking whether a plurality of lock modules are enabled; and
enabling a disabled lock module in accordance with an enabled lock module, if at least one of the plurality of lock modules is enabled.
